(19) United States
(12) Patent Application Publication
(10) Pub. No.: US 2013/0099956 A1
(43) Pub. Date: Apr. 25, 2013

(54) APPARATUS TO REDUCE SPECIFIC ABSORPTION RATE

(71) Applicant: Roger A. Fratti, Mohnton, PA (US)

(72) Inventor: Roger A. Fratti, Mohnton, PA (US)

(73) Assignee: LSI Corporation

(21) Appl. No.: 13/279,542

(22) Filed: Oct. 24, 2011

(51) Int. Cl. H01Q 17/00

(52) U.S. Cl. 342/1

(57) ABSTRACT

In described embodiments, a user is protected from potential health risks from emitted RF energy from a wireless handset or other device by reducing Specific Absorption Rate (SAR) of the device while avoiding, or even improving, the radiation pattern of the antenna. For example, a hat, cap or other covering of a device user's upper body includes a dual-layer structure comprising of carbon-loaded, open cell foam with a metalized layer. The dual-layer structure is imbedded in, for example, a hat with the carbon loaded foam facing away from the user's head. The covering provides for RF protection of the user to reduce SAR while maintaining relatively good return loss characteristics, thereby avoiding a negative impact on the desired antenna radiation pattern of the device.

### BACKGROUND OF THE INVENTION

1. Field of the Invention

The present invention relates to protective devices for absorption of radio frequency energy, and, in particular, to protective materials configured to absorb radiated energy of wireless communication devices.

2. Description of the Related Art

Portable communication devices, such as cellular telephones generally use an antenna for the transmission and reception of radio frequency signals. Present antennas experience capacitive and inductive coupling to the body of the user. Coupling degrades the performance of the antenna, and ultimately the communication device, due to reflection, diffraction and dissipation by the Joule effect of the RF (Radio Frequency) energy by the body of the user. The head, especially, is very conductive and absorbs RF energy, while also acting as a lossy ground plane that re-directs RF energy.

In addition, scientific studies have shown potential health risks, such as DNA breakage, associated with human exposure to radio wave sources, such as those emitted from the antenna of a mobile telephone device and/or handset. Consequently, cellular telephones, satellite telephones, cordless telephones, and also portable computers, including those equipped with WiFi connectivity capacity, might pose potential long-term health risks to their users.

Microwaves are absorbed by living tissues at 24 times the rate of their absorption by pure water. While the Specific Absorption Rate (SAR), one standard by which cellular microwave absorption by the body is commonly measured, is typically based upon a penetration through an inert emulation of a human head, other experimental evidence indicates that the level of absorption in living tissue is many times greater than the level of microwave absorption through an inert liquid, such as water.

SAR measures exposure to fields between 100 kHz and 10 GHz. The SAR value calculated depends on the geometry of the part of the body that is exposed to the RF energy, and on the exact location and geometry of the RF source. Thus, tests must be made with each specific source, such as a mobile phone model, and at the intended position of use. For example, when measuring the SAR due to a mobile phone the phone is placed at the head in a talk position. The SAR value is then measured at the location that has the highest absorption rate in the entire head, which in the case of a mobile phone is often as close to the phone's antenna as possible.

Various governments have defined safety limits for exposure to RF energy produced by mobile devices that mainly exposes the head or a limb for the RF energy. in the United States, the FCC requires that mobile phones have a SAR level at or below 1.6 watts per kilogram (W/kg) taken over a volume containing a mass of 1 gram of tissue. In the European Union: CENELEC specifies SAR limits within the EU, following IEC standards. For mobile phones, and other such hand-held devices, the SAR limit of the IEC standards is 2 W/kg averaged over 10 g of tissue (IEC 62209-1).

Currently, while the safety issues for mobile RF sources are recognized, most techniques employed to reduce SAR focus on covering the RF emission source antenna or the device itself, which might negatively affect the transmission capabilities of the mobile device.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, the present invention allows for reducing radio frequency (RF) energy absorbed by a user of a wireless communication device. A covering covers a portion of the user adjacent to the wireless communication device; and a dual-layer structure is positioned within the covering that absorbs and reflects RF energy. The dual-layer structure includes an RF absorptive layer, and a metalized layer positioned between the RF absorptive layer and the portion of the user adjacent to the wireless communication device. The RF absorptive layer is positioned between the metalized layer and the wireless communication device.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 shows an exemplary embodiment of the present invention having a cap including a dual-layer structure;

FIG. 2 shows an exemplary dual-layer structure as might be employed by the embodiment of FIG. 1;

FIG. 3 shows effects of the cap of FIG. 1 when placed between a user's head and a wireless device antenna emitting radiation;

FIG. 4 shows an exemplary circuit diagram employed to model electrical behavior of exemplary embodiments of the present invention;

FIG. 5 shows an exemplary table of electrical characteristics for material associated with the circuit diagram of FIG. 4; and

FIGS. 6A-6D show a set of S-parameter attenuation versus frequency graphs for the circuit diagram of FIG. 4.

### DETAILED DESCRIPTION

In accordance with described embodiments, a user is protected from potential health risks from emitted RF energy from a wireless handset or other device by reducing Specific Absorption Rate (SAR) of the device while avoiding, or even improving, the radiation pattern of the antenna. In some embodiments, a hat, cap, a scarf, a tie, or other covering of a device user's upper body includes a dual-layer structure comprising of carbon-loaded, open cell foam with a metalized layer. The dual-layer structure is imbedded in, for example, a hat with the carbon loaded foam facing away from the user's head. A covering in accordance with embodiments of the present invention provides for RF protection of the user to reduce SAR while maintaining relatively good return loss characteristics, thereby avoiding a negative impact on the desired antenna radiation pattern of the device.

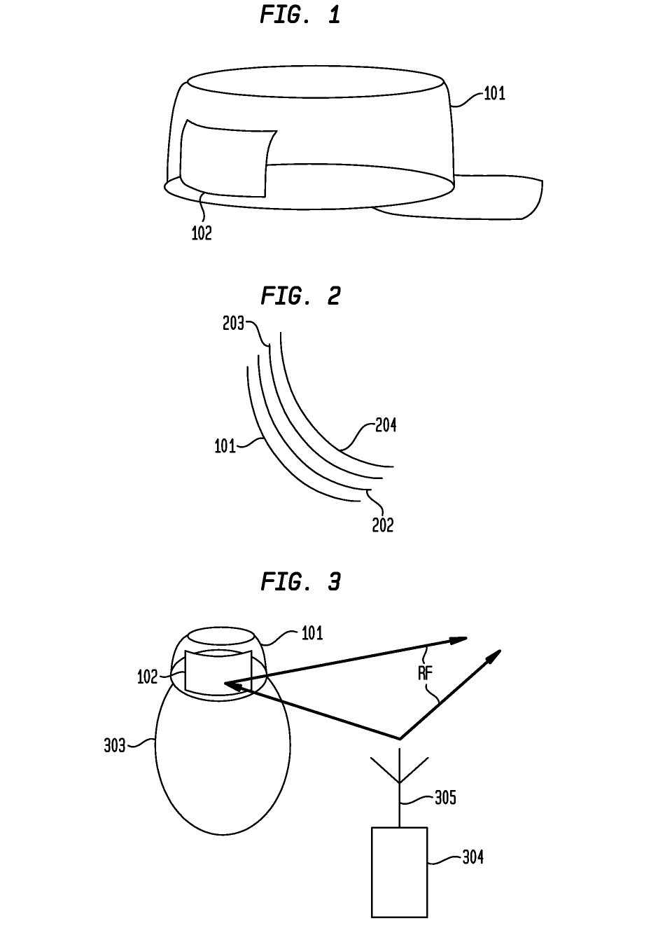

FIG. 1 shows an exemplary embodiment of the present invention having cap 101 including a dual-layer structure 102 providing RF protection to a user. As shown in FIG. 1, dual-layer structure 102 is within cap 101 so as to cover an area in near proximity to the user's ear. FIG. 2 shows an exemplary dual-layer structure as might be employed by the embodiment of FIG. 1. Dual layer structure 102 comprises an RF absorptive layer 203 adjacent to the inside of cap 101 and with metalized layer 204. For example, RF absorptive layer 203 might be a carbon-loaded, open cell foam layer and the metalized layer might either be a silk screened thick film metal or an adhesive backed metal film.

Optional layer 202 is shown adjacent to inside surface of cap 101 and represents an adhesive layer that might be employed to affix dual layer structure 102 (at layer 203) to cap 101. Alternatively, dual layer structure 102 might simply be sewn into cap 101, or might be incorporated as an inside liner of cap 101. While the present embodiment is described with respect to a cap for a user's head, the present invention is not so limited. One skilled in the art might extend the teachings herein to other forms of protective clothing of the user's head and/or upper body to reduce SAR.

FIG. 3 shows effects of cap 102 of FIG. 1 having dual layer structure 102 when placed between a user's head 303 and a wireless device 304 with antenna 305 emitting RF radiation. RF energy is received and reflected by dual layer structure 102, thereby redirecting RF energy and reducing SAR. For preferred embodiments, the reflected wave is relatively small compared to the direct wave. Wireless device 304 might be selected from, but not limited to, a hand-held mobile wireless phone, a satellite radio phone, and a WiFi device operating in accordance with one or more of IEEE 802.11, IEEE 802.15, and IEEE 802.16 standards.

Materials employed for absorption of microwave energy might include lossy, flexible foam products for layer 202, such as Eccosorb® LS available from Emerson and Cuming Microwave Products of 28 York Avenue, Randolph, Mass. Preferred embodiments might employ Eccosorb® LS-26/SS-3 with a conductive metalized layer, and might incorporate other layers (not shown in FIG. 2) that provide for waterproofing or other types of environmental protection for dual layer structure 102.

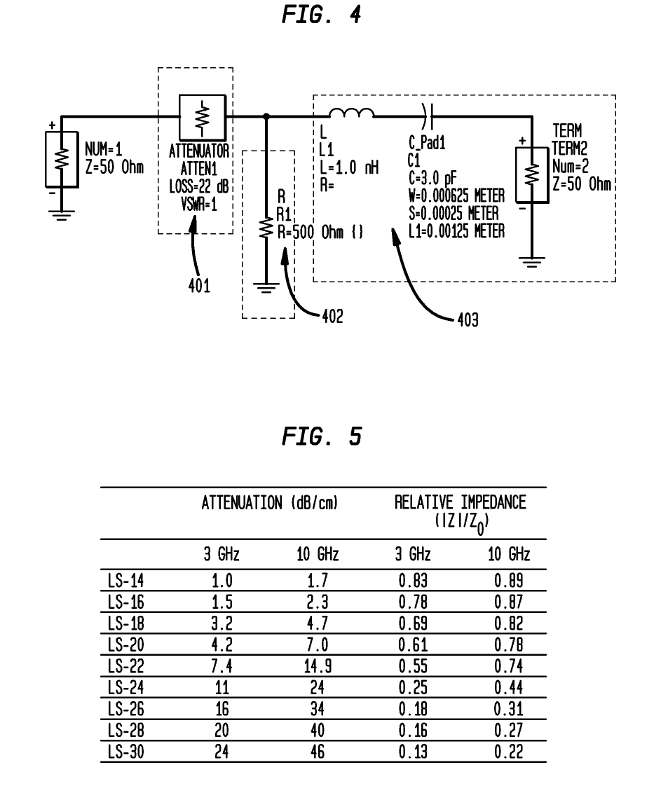

FIG. 4 shows a diagram of an exemplary circuit 400 employed to model electrical behavior of exemplary embodiments of the present invention, and comprises circuits 401, 402, and 403. Circuit 401 is a lumped model representing the insertion loss, or attenuation of the carbon-loaded, open cell foam layer 202. Circuit 402 represents conductive layer 203 attached to the back of layer 202 represented by circuit 401. The impedance of this conductive layer might be changed from a relatively low, or near-zero impedance, which represents conductive layer 203 as used in embodiments of the present invention. The impedance of this conductive layer might be changed to a high impedance, such as 500 ohms, to simulate the effectiveness of layer structure without presence of conductive layer 203 in dual layer structure 102. Using this model allows simulation of both reflected signal energy and transmitted energy into the human head simultaneously. Circuit 403 represents a lumped equivalent model of the human head. Since the human body contains water this first order approximation is a lossy resonance near 2.4 GHz.

Thus, returning to FIG. 4, carbon-loaded, open cell foam layer 202 modeled as circuit 401 having attenuator 411 in series with resistor 410 to ground. Metalized layer 204 is modeled as circuit 402 with resistor 412 coupled between ground and the output of attenuator 411. To provide a first order absorption model, circuit 403 . Circuit 403 comprises a series coupled inductor 413, capacitor 414, and resistor 415. Circuit 403 is coupled between the output of attenuator 411 and ground.

For the exemplary circuit diagram of FIG. 4, a source of electrical characteristics provides attenuation and relative impedance information for deriving some of the modeled circuit elements based on particular materials selected for carbon-loaded, open cell foam layer 202 modeled as circuit 401. The table of FIG. 5 illustrates attenuation and relative impedance values for various Eccosorb® LS materials for 3 GHz and 10 GHz RF frequencies.

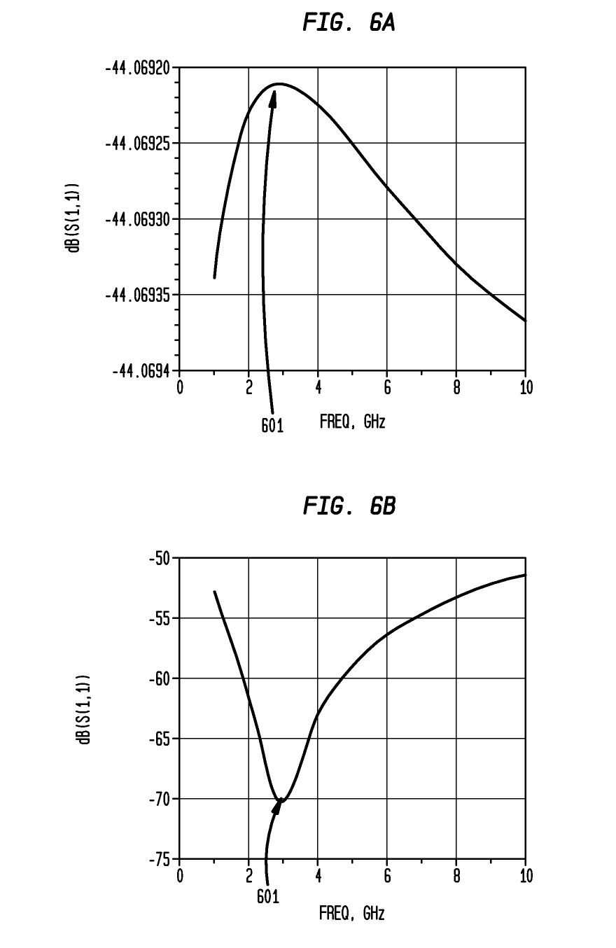

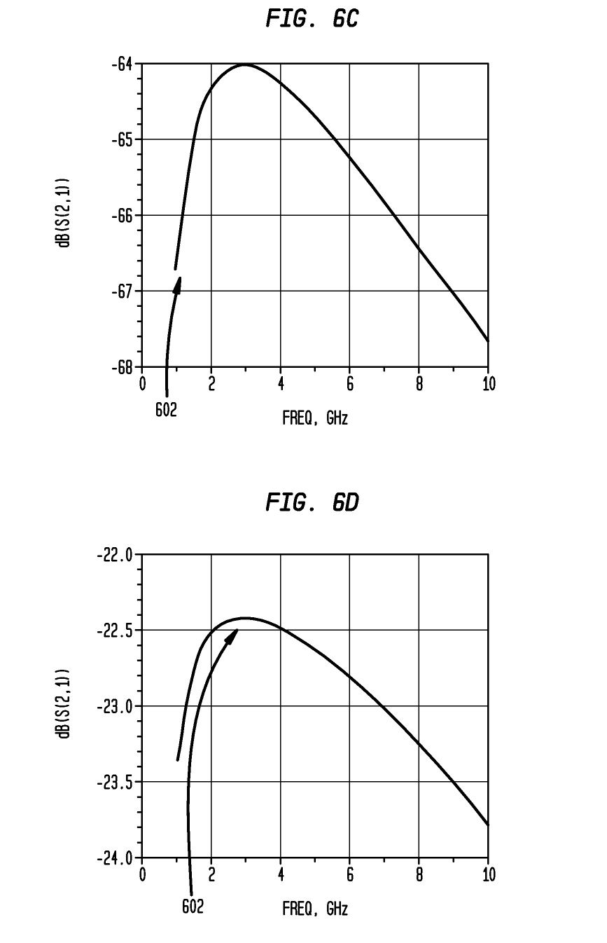

Return loss and transmission characteristics using the combined circuit models of FIG. 4 are shown in FIGS. 6A-6D. FIGS. 6A-6D show a set of S-parameter attenuation versus frequency graphs for the circuit diagram of FIG. 4. As shown in FIGS. 6A-6D, the circuit of FIG. 4 is substantially transparent to, for example, phone operation. FIGS. 6A and 6B illustrate that the relative return loss values 601 for the exemplary circuit 400 with and without the conductive layer. FIG. 6A illustrates that the relative return loss value when the conductive layer is present indicates that the exemplary circuit 400 exhibits little or no significant reflected power. In contrast, FIG. 6B shows the return loss of the layer structure without the metal inter-layer exhibits significant reflected power. FIGS. 6C and 6D illustrate that the relative attenuation values 602 indicate that the exemplary circuit 400 exhibits at least 40 dB better protection from absorbed RF power. FIG. 6C shows the amount of signal energy that makes its way through the absorber layer and metal shielding layer into the lumped equivalent of the head. As shown in FIG. 6C, the model shows this value to be approximately −64 dB, an extremely low amount. By comparison, FIG. 6D shows the amount of signal energy that makes its way through to the head with only the absorber layer. The added conductive layer dramatically improves the performance without severely degrading the return loss (i.e., the return loss difference of −44 to −65 between cases is relatively insignificant).

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. Unless explicitly stated otherwise, each numerical value and range should be interpreted as being approximate as if the word “about” or “approximately” preceded the value of the value or range.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

It will be further understood that various changes in the details, materials, and arrangements of the parts which have been described and illustrated in order to explain the nature of this invention may be made by those skilled in the art without departing from the scope of the invention as expressed in the following claims.

We claim:

1. An apparatus for reducing radio frequency (RF) energy absorbed by a user of a wireless communication device, the apparatus comprising:
a covering configured to cover a portion of the user adjacent to the wireless communication device;
a dual-layer structure positioned within the covering and adapted to absorb and to reflect RF energy, the dual-layer structure comprising:
an RF absorptive layer, and
a metalized layer positioned between the RF absorptive layer and the portion of the user adjacent to the wireless communication device,
wherein the RF absorptive layer is positioned between the metalized layer and the wireless communication device.

2. The apparatus of claim 1, wherein the covering is at least one of a hat, cap, a scarf, and a tie.

3. The apparatus of claim 1, wherein the RF absorptive layer includes a carbon-loaded, open cell foam material.

4. The apparatus of claim 1, wherein the metalized layer is selected from at least one of a silk screened thick film metal or an adhesive backed metal film.

5. The apparatus of claim 1, wherein the wireless communication device is at least one of a hand-held mobile wireless phone, a satellite radio phone, and a WiFi device operating in accordance with one or more of IEEE 802.11, IEEE 802.15, and IEEE 802.16 standards.

6. The apparatus of claim 1, further comprising an adhesion layer between an inside surface of the covering and the dual-layer structure, the adhesion layer configured to attach the dual-layer structure to the covering.

7. The apparatus of claim 1, further comprising a protective layer about the dual-layer structure, the protective layer configured to protect the dual-layer structure from environmental conditions.

8. A method of reducing radio frequency (RF) energy absorbed by a user of a wireless communication device, the apparatus comprising:
covering a portion of the user adjacent to the wireless communication device with an article;
positioning a dual-layer structure within the article, thereby absorbing and reflecting RF energy by the dual-layer structure,
wherein the dual-layer structure comprises i) an RF absorptive layer and ii) a metalized layer between the RF absorptive layer and the portion of the user adjacent to the wireless communication device, the RF absorptive layer between the metalized layer and the wireless communication device.

9. The method of claim 8, wherein the covering covers with an article that is at least one of a hat, cap, a scarf, and a tie.

10. The method of claim 8, wherein the RF absorptive layer includes a carbon-loaded, open cell foam material.

11. The method of claim 8, wherein the metalized layer is at least one of a silk screened thick film metal or an adhesive backed metal film.

12. The method of claim 8, wherein the wireless communication device is at least one of a hand-held mobile wireless phone, a satellite radio phone, and a WiFi device operating in accordance with one or more of IEEE 802.11, IEEE 802.15, and IEEE 802.16 standards.

13. The method of claim 8, further comprising placing an adhesion layer between an inside surface of the covering and the dual-layer structure, thereby attaching the dual-layer structure to the covering with the adhesion layer.

14. The method of claim 8, further comprising providing a protective layer about the dual-layer structure, thereby protecting the dual-layer structure from environmental conditions.
